(19) United States
(12) Patent Application Publication
(10) Pub. No.: US 2025/0307342 A1
(43) Pub. Date: Oct. 2, 2025

(54) INFORMATION PROCESSING APPARATUS, INFERENCE MODEL GENERATION METHOD, INFERENCE METHOD, AND STORAGE MEDIUM

(71) Applicant: NEC Corporation, Tokyo (JP)

(72) Inventor: Ryota HIGA, Tokyo (JP)

(73) Assignee: NEC Corporation, Tokyo (JP)

(21) Appl. No.: 19/073,434

(22) Filed: Mar. 7, 2025

(30) Foreign Application Priority Data
Mar. 29, 2024 (JP) 2024-055513

(51) Int. Cl. G06F 17/11; G06N 3/0455; G06N 3/092

(52) U.S. Cl. CPC G06F 17/11; G06N 3/0455; G06N 3/092

(57) ABSTRACT

In order to make it possible to achieve improvement in inference of a solution to a combinational optimization problem, an information processing apparatus includes: a data acquisition section that acquires input data pertaining to a combinational optimization problem for which a solution is to be obtained; and an inference section that infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

This Nonprovisional application claims priority under 35 U.S.C. § 119 on Patent Application No. 2024-055513 filed in Japan on Mar. 29, 2024, the entire contents of which are hereby incorporated by reference.

### TECHNICAL FIELD

The present disclosure relates to an information processing apparatus, an inference model generation method, an inference method, and a storage medium.

### BACKGROUND ART

A technique is known in which problems in business are solved by applying, to business and the like, various kinds of combinational optimization problems such as a vehicle routing problem. For example, Patent Literature 1 discloses a transportation plan preparation assistance method that assists preparation of an optimum transportation plan in transportation planning in which a plurality of delivery vehicles carry out delivery operations thereof while satisfying various constraint conditions.

### CITATION LIST

### Patent Literature

### [Patent Literature 1]

Japanese Patent Application Publication Tokukai No. 2024-17959

### SUMMARY OF INVENTION

### Technical Problem

The transportation plan preparation assistance method disclosed in Patent Literature 1 has room for improvement in that input data that need to be inputted to prepare an optimum transportation plan and output data that is outputted by optimization calculation are both fixed data. This is not limited to transportation plans, and is common in cases of handling arbitrary combinational optimization problems.

The present disclosure is accomplished in view of the above problem, and an example object thereof is to provide a technique which makes it possible to achieve improvement in inference of a solution to a combinational optimization problem.

### Solution to Problem

An information processing apparatus in accordance with an example aspect of the present disclosure includes at least one processor, the at least one processor carrying out: a data acquisition process of acquiring input data pertaining to a combinational optimization problem for which a solution is to be a obtained; and an inference process of inferring solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

An inference model generation method in accordance with an example aspect of the present disclosure includes: an inference process in which at least one processor infers a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and an updating process in which the at least one processor updates the inference model by reinforcement learning based on a result of evaluation of a solution which has been obtained in the inference process.

An inference method in accordance with an example aspect of the present disclosure includes: a data acquisition process in which at least one processor acquires input data pertaining to a combinational optimization problem for which a solution is to be obtained; and an inference process in which the at least one processor infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

A storage medium in accordance with an example aspect of the present disclosure is a computer-readable non-transitory storage medium that stores an inference program for causing a computer to carry out: a data acquisition process of acquiring input data pertaining to a combinational optimization problem for which a solution is to be obtained; and an inference process of inferring a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

### Advantageous Effects of Invention

An example aspect of the present disclosure brings example advantage of providing a technique that makes it possible to achieve improvement in inference of a solution to a combinational optimization problem.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an inference method in accordance with the present disclosure.

FIG. 3 is a block diagram illustrating a configuration of another information processing apparatus in accordance with the present disclosure.

FIG. 4 is a flowchart illustrating a flow of an inference model generation method in accordance with the present disclosure.

FIG. 5 is a diagram illustrating an overview of an optimization assistance system in accordance with the present disclosure.

FIG. 6 is a block diagram illustrating a configuration of still another information processing apparatus in accordance with the present disclosure.

FIG. 7 is a diagram illustrating an example configuration of an encoder included in an inference model.

FIG. 8 is a diagram illustrating an example in which an optimum delivery route is inferred using an inference model including the encoder illustrated in FIG. 7.

FIG. 9 is a diagram illustrating an example of additional training of an inference model.

FIG. 10 is a flowchart illustrating a flow of a process carried out by the information processing apparatus illustrated in FIG. 6.

FIG. 11 is a block diagram illustrating a configuration of a computer which functions as the information processing apparatus in accordance with the present disclosure.

### EXAMPLE EMBODIMENTS

The following description will discuss example embodiments of the present invention. The present invention is not limited to the example embodiments below, but may be altered in various ways by a skilled person within the scope of the claims. For example, the present invention can also encompass, in its scope, any example embodiment derived by appropriately combining techniques (part of or all of products or methods) employed in the example embodiments described below. Alternatively, the present invention may also encompass, in its scope, any example embodiment derived by appropriately omitting part of techniques employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that an application scope of techniques which are employed in the present example embodiment is not limited to the present example embodiment. That is, techniques employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

### (Configuration of Information Processing Apparatus 1)

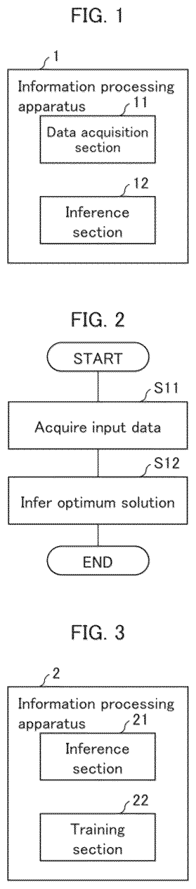

The following description will discuss a configuration of an information processing apparatus 1, with reference to FIG. 1. FIG. 1 is a block diagram illustrating the configuration of the information processing apparatus 1. As illustrated in FIG. 1, the information processing apparatus 1 includes a data acquisition section 11 and an inference section 12.

The data acquisition section 11 acquires input data pertaining to a combinational optimization problem (hereinafter abbreviated to “optimization problem” as appropriate) for which a solution is to be obtained. This input data only needs include information necessary for inferring a solution to the optimization problem, and it is possible to use various types of data such as text, numerical values, and images.

Here, data used for an optimization problem in the real world takes a form that differs in accordance with characteristics or requirements of the problem. As described above, the information processing apparatus 1 can employ various types of data as input data, and is therefore adaptive with respect to data characteristics of an optimization problem in the real world.

For example, in a case where the optimization problem is a traveling salesman problem, the input data may be a list indicating coordinates of spots of interest. The coordinates are typically expressed by the latitude and longitude or as points on an XY plane. Alternatively, the input data may be information indicating spots of interest and routes connecting those spots (e.g., graph data indicating the spots as nodes and the routes connecting those spots as edges).

Furthermore, a constraint condition of the optimization problem may be included in the input data, or various kinds of information which are not essential for solving the optimization problem but are preferable to consider may be included in the input data. For example, in a traveling salesman problem, it is assumed that optimization is attempted on the premise of asymmetry in which passage costs vary between going and returning even for the same route. In this case, a cost matrix for expressing the asymmetry may be included in the input data.

In a case where the optimization problem is a vehicle routing problem, the input data may include information indicating constraints such as each moving object (e.g., a delivery truck) used for delivery and a load capacity thereof, in addition to positional information such as a delivery destination. In a case where the optimization problem is a pick and delivery problem, the input data may include information such as a pickup location and a delivery location. In a case where the optimization problem is a job shop scheduling problem, it is necessary to minimize a total work time while taking into consideration that the work time varies in accordance with an execution order of work. By including a cost matrix in the input data, it is possible to decide an optimum execution order or the like while taking into consideration such a change in work time.

The information processing apparatus 1 is suitable for inference of a solution to an optimization problem in which an order needs to be considered, as described above. In addition, the information processing apparatus 1 can also be applied to inference of a solution to a problem (such as a knapsack problem) in which it is not necessary to consider an order. In a case where the optimization problem is a knapsack problem, the input data is a list of items, and each item is expressed by a pair of a weight and a value (such as a price). Note that the input data may be transformed into a format that is predetermined in accordance with a type of problem.

The inference section 12 infers, with use of an inference model for inferring a solution to the optimization problem, a solution in accordance with the input data acquired by the data acquisition section 11. The inference model is an inference model which has been generated by reinforcement learning and includes an encoder that extracts a feature of the input data and a decoder that generates information indicating a solution to the optimization problem using the feature extracted by the encoder.

As described above, the information processing apparatus 1 includes: the data acquisition section 11 that acquires input data pertaining to a combinational optimization problem for which a solution is to be obtained; and the inference section 12 that infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder. This configuration brings about an example advantage of making it possible to achieve improvement in inference of a solution to a combinational optimization problem.

More specifically, according to the above configuration, feature extraction is carried out by the encoder, and the extracted feature is used to generate, by the decoder, information indicating a solution to an optimization problem. In other words, data points included in the input data are transformed into higher dimensional internal state vectors (also referred to as “embedding vectors”) by the encoder. By this transformation, relationships between pieces of data and structures are expressed by a model. Thus, the input data is not directly used for generation of information indicating a solution to an optimization problem. Therefore, as long as a feature can be extracted by the encoder, it is possible to accept various kinds of input data as described above. Therefore, a degree of freedom of input in the information processing apparatus 1 is high.

According to the above configuration, the decoder generates information indicating a solution to the optimization problem. That is, the decoder generates an optimum solution using the internal state vectors obtained from the encoder. Past inference results are reflected in training of the inference model. Therefore, it can be said that the optimum solution generated in such a manner has been decided while taking into consideration the internal state vectors generated by the encoder, past inference results, and evaluation results thereof.

An output format of the decoder can be determined as appropriate in designing an inference model, and it is also possible to change the output format by additional training. Therefore, it can be said that a degree of freedom of output is also high in the information processing apparatus 1.

Here, in a case where it is possible to apply a variety of input data, input data which is insufficient for inference of a solution to the optimization problem may be acquired. For example, in a case of solving an optimization problem that handles geographical information, there is a possibility that using only words or a simple label indicating a geographical position as input data cannot capture important elements such as an actual distance, directional property, and a positional relationship. For example, it is difficult, from text “I want to go to Tokyo from New York” to directly read an actual distance and direction from New York to Tokyo, a means of transportation, and the like.

However, the inference model used in the information processing apparatus 1 is generated by reinforcement learning. Through a reinforcement learning process, the encoder is updated to be able to extract a feature that more accurately reflects, for example, a geographical structure and other important relationships which are not directly expressed in the input data. Therefore, the information processing apparatus 1 makes it possible to obtain an appropriate inference result even in a case where insufficient input data is inputted.

Combinational optimization problems such as a traveling salesman problem are known as problems that are frequently encountered in actual business but are NP-hard problems. In a case where such an optimization problem is solved by an optimization-based method as in Patent Literature 1, it is known that, as a problem size increases, a time taken for optimum solution calculation increases significantly, and it is difficult to obtain an optimum solution in a practicable degree of time. In this regard, according to the information processing apparatus 1, inference is carried out using the inference model which has been trained in advance. Therefore, even in a case where a problem size increases, a degree of increase in time taken for inference is suppressed. Therefore, application to various kinds of business is realistic.

As described above, the information processing apparatus 1 can collect information from various input sources and generate an appropriate solution to a combinational optimization problem. The encoder calculates a feature of data by transforming the input data into a higher dimensional feature space, and enables the subsequent decoder to calculate an optimum solution based on the feature. Therefore, according to the information processing apparatus 1, regardless of the form of input data, information necessary for deriving an optimum solution such as an accurate geographical relationship can be incorporated into an internal state (a feature outputted by the encoder).

### (Inference Program)

The functions of the foregoing information processing apparatus 1 can be implemented also by a program. An inference program in accordance with the present example embodiment causes a computer to function as: a data acquisition means that acquires input data pertaining to a combinational optimization problem for which a solution is to be obtained; and an inference means that infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder. Therefore, the inference program in accordance with the present example embodiment brings about an example advantage of making it possible to achieve improvement in inference of a solution to a combinational optimization problem.

### (Flow of Inference Method)

The following description will discuss a flow of an inference method, with reference to FIG. 2. FIG. 2 is a flowchart illustrating the flow of the inference method. Note that an execution subject of each of steps in the inference method may be a processor that is included in the information processing apparatus 1 or may be a processor that is included in another apparatus. That is, execution subjects of respective steps may be processors provided in different apparatuses.

In S11 (data acquisition process), at least one processor acquires input data pertaining to a combinational optimization problem for which a solution is to be obtained.

In S12 (inference process), the at least one processor infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

As described above, the inference method in accordance with the present example embodiment includes: a data acquisition process in which at least one processor acquires input data pertaining to a combinational optimization problem for which a solution is to be obtained; and an inference process in which the at least one processor infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder. Therefore, it is possible to bring about an example advantage of making it possible to achieve improvement in inference of a solution to a combinational optimization problem.

### (Configuration of Information Processing Apparatus 2)

The following description will discuss a configuration of an information processing apparatus 2, with reference to FIG. 3. FIG. 3 is a block diagram illustrating the configuration of the information processing apparatus 2. As illustrated in FIG. 3, the information processing apparatus 2 includes an inference section 21 and a training section 22.

The inference section 21 infers a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder. As with the input data used for inference in the information processing apparatus 1 described above, the input data used for this inference only needs to include information necessary for inferring a solution to an optimization problem and be data from which a feature can be extracted by the encoder.

The training section 22 updates the inference model by reinforcement learning based on a result of evaluation of a solution inferred by the inference section 21. The reinforcement learning algorithm is an arbitrary algorithm. For example, the training section 22 may update the inference model by a method such as a policy gradient method (more precisely, update parameters of the encoder and the decoder included in the inference model).

As described above, the information processing apparatus 2 includes: the inference section 21 for inferring a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and the training section 22 for updating the inference model by reinforcement learning based on a result of evaluation of a solution which has been inferred by the inference section 21.

According to the above configuration, it is possible to generate an inference model which can accept a variety of input data. An output format of the decoder included in the inference model can be determined as appropriate in designing the inference model, and it is also possible to change the output format by fine-tuning. Therefore, it can be said that a degree of freedom of output of an inference model generated by the information processing apparatus 2 is high. Therefore, the above configuration brings about an example advantage of making it possible to achieve improvement in inference of a solution to a combinational optimization problem.

Note that, in reinforcement learning, a solution inferred by the inference section 21 is evaluated. Then, evaluation of the solution is carried out based on a reward calculated using a predetermined reward function. The reward is, in other words, an evaluation value which indicates how much the inferred solution satisfies an actual requirement or purpose of an optimization problem of interest. In reinforcement learning carried out by the training section 22, a reward function to be applied may be appropriately decided in accordance with an optimization problem of interest, constraint conditions to be applied, and the like. For example, a reward in an optimization problem that handles geographical information may be calculated based on actual data such as a map. As a specific example, in a traveling salesman problem, a higher reward may be given to a route having a shorter distance on a map.

### (Training Program)

The functions of the foregoing information processing apparatus 1 can be implemented also by a program. A training program in accordance with the present example embodiment causes a computer to function as: an inference means for inferring a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and a training means for updating the inference model by reinforcement learning based on a result of evaluation of a solution which has been inferred by the inference means. Therefore, the training program in accordance with the present example embodiment brings about an example advantage of making it possible to achieve improvement in inference of a solution to a combinational optimization problem.

### (Flow of Inference Model Generation Method)

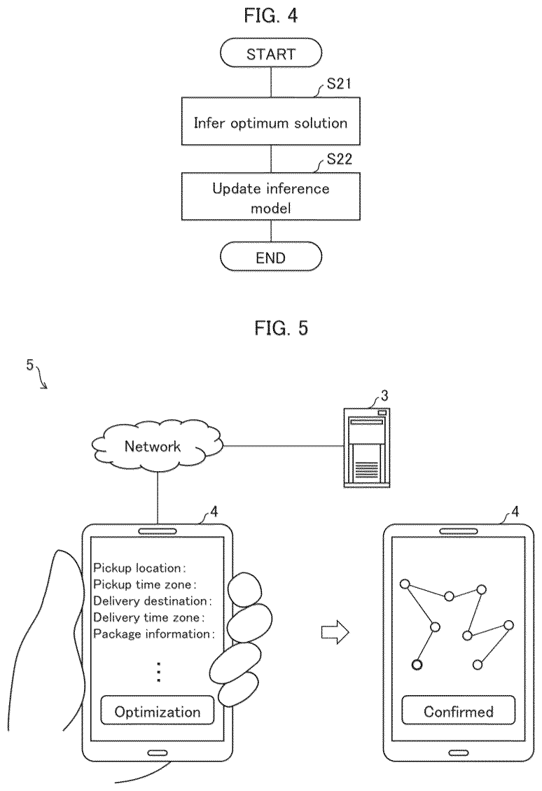

The following description will discuss a flow of an inference model generation method, with reference to FIG. 4. FIG. 4 is a flowchart illustrating the flow of the inference model generation method. Note that an execution subject of each of steps in the inference model generation method may be a processor that is included in the information processing apparatus 2 or may be a processor that is included in another apparatus. That is, execution subjects of respective steps may be processors provided in different apparatuses.

In S21 (inference process), at least one processor infers a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder.

In S22 (updating process), at least one processor updates the inference model by reinforcement learning based on a result of evaluation of the solution inferred in S21.

As described above, the inference model generation method in accordance with the present example embodiment includes: an inference process in which at least one processor infers a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and an updating process in which the at least one processor updates the inference model by reinforcement learning based on a result of evaluation of a solution which has been obtained in the inference process. Therefore, it is possible to bring about an example advantage of making it possible to achieve improvement in inference of a solution to a combinational optimization problem. Note that an inference model generated by the above generation method is also encompassed in the scope of the present invention.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that an application scope of techniques which are employed in the present example embodiment is not limited to the present example embodiment. That is, techniques employed in the present example embodiment can be employed also in the other example embodiments included in the present disclosure, within a range in which no particular technical problem occurs. Moreover, techniques indicated in the drawings referred to for describing the present example embodiment can be employed also in the other example embodiments included in the present disclosure, within a range in which no particular technical problem occurs.

### (Configuration of Optimization Assistance System 5)

The following description will discuss a configuration of an optimization assistance system 5, with reference to FIG. 5. FIG. 5 is a diagram illustrating an overview of the optimization assistance system 5. The optimization assistance system 5 is a system having a function of inferring a solution to a combinational optimization problem. As illustrated in FIG. 5, the optimization assistance system 5 includes an information processing apparatus 3 which carries out various kinds of processes for realizing the above functions and a terminal apparatus 4 used by a user of the optimization assistance system 5.

The following description will discuss an example in which an optimum delivery route of a package is inferred by the optimization assistance system 5. In a case where one vehicle (e.g., a truck) is used for delivery, an optimization problem to be solved is a traveling salesman problem. In a case where a plurality of vehicles are used for delivery, an optimization problem to be solved is a vehicle routing problem. Note that the optimization assistance system 5 can infer a solution to an arbitrary combinational optimization problem. For example, it is possible to infer a solution to a knapsack problem by the optimization assistance system 5.

The user of the optimization assistance system 5 is, for example, a delivery planner of a logistics company. The user, on a daily basis, has to process orders with a large number of pickup locations and delivery destinations and to plan efficient delivery routes using a limited number of trucks and drivers. First, the user inputs various pieces of information necessary for inferring an optimum delivery route of a package via a graphical user interface (GUI) displayed on the terminal apparatus 4.

FIG. 5 illustrates an example in which the terminal apparatus 4 is a smart phone. The terminal apparatus 4 only needs to include functions to: accept input of necessary information via GUI; transmit the inputted information to the information processing apparatus 3 via a network such as the Internet; receive a result of inference based on the information from the information processing apparatus 3; and present the result to the user. For example, the terminal apparatus 4 may be a personal computer.

In the example of FIG. 5, a display section of the terminal apparatus 4 displays a form for inputting a pickup location, a desired pickup time zone, a delivery destination, a desired delivery time zone, and information pertaining to a package (e.g., a weight and size of the package). The user inputs the above pieces of information to the form via a touch panel of the terminal apparatus 4 and, upon completion of the input, the user may select a button displaying “optimization”. Thus, the inputted information is transmitted to the information processing apparatus 3 via the network.

The information processing apparatus 3 acquires the transmitted information as input data pertaining to an optimization problem of inferring an optimum delivery route and starts an optimization process f of the delivery route. Specifically, the information processing apparatus 3 first extracts a feature of the input data using a trained encoder. This process is, in other words, a process of transforming input data into an internal state vector. The internal state vector (feature) includes, for example, information such as a geographical positional relationship between a pickup location and a delivery destination, a temporal constraint due to a desired time zone, and a constraint on a load capacity due to the weight and size of the package.

Next, the information processing apparatus 3 optimizes the internal state vector while taking into consideration past delivery record data. Using this optimized internal state vector, the trained decoder generates a most efficient delivery route which satisfies the constraints of the number of trucks and the working hours of the drivers.

The generated optimum delivery route is transmitted to the terminal apparatus 4 via the network and displayed on the display section of the terminal apparatus 4. A presentation mode of the delivery route is an arbitrary mode. For example, as illustrated in FIG. 5, the information processing apparatus 3 may cause an image of the map to be displayed on which the generated delivery route is superimposed. The information processing apparatus 3 may accept modification by the user to the displayed delivery route. The modification by the user is carried out via an input apparatus such as a touch panel included in the terminal apparatus 4.

Then, the user may select a button displaying “confirmed” in a state in which an intended delivery route is displayed. Thus, route guidance is started along the delivery route. The route guidance may be carried out by the information processing apparatus 3 or may be carried out by a navigation application installed in the terminal apparatus 4 or an in-vehicle navigation apparatus. Thus, the user can check the delivery route for which the user is responsible and efficiently carry out pickup and delivery using the navigation function.

A progress of the delivery is fed back to the information processing apparatus 3 in real time via a ground positioning system (GPS) function of the terminal apparatus 4. Based on the feedback, the information processing apparatus 3 causes a spot(s) at which delivery has been completed and a spot(s) at which delivery has not been completed to be displayed in a discernible manner. Thus, the progress of delivery can be ascertained at a glance. Upon completion of the delivery, data such as a time taken and a distance traveled for actual delivery is transmitted to the information processing apparatus 3 and is utilized for optimization of a delivery route for the next time.

As described above, the optimization assistance system 5 automatically generates an optimum delivery route while taking into consideration complicated constraint conditions. Thus, it is possible to greatly reduce time and labor taken for drafting a delivery plan and to greatly improve efficiency of daily work of the user. Moreover, quality of delivery routes is improved day by day through s training utilizing past data. The optimization assistance system 5 brings about a great example advantage in various aspects of logistics operations, such as reduction in delivery costs, improvement in customer satisfaction, and reduction in burden on drivers. As a source of competitiveness in the logistics industry, utilization of the optimization assistance system 5 is greatly expected. The optimization assistance system 5 can also be applied to the medical and healthcare field such as optimization of a visit route in a case where a doctor carries out home-visit medical care and optimization of a menu of rehabilitation or workout.

### (Configuration of Information Processing Apparatus 3)

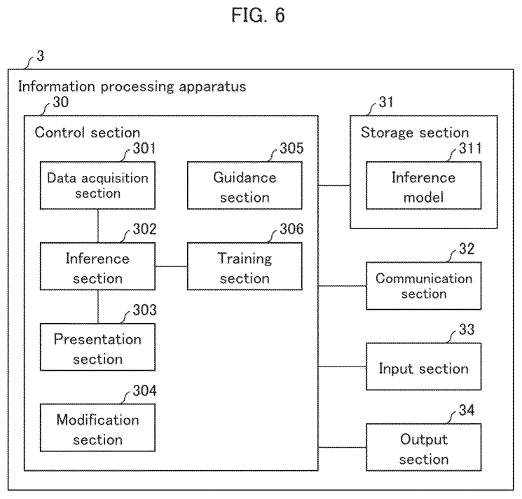

The following description will discuss the configuration of the information processing apparatus 3, with reference to FIG. 6. FIG. 6 is a block diagram illustrating the configuration of the information processing apparatus 3. As illustrated in FIG. 6, the information processing apparatus 3 includes: a control section 30 that comprehensively controls constituent elements of the information processing apparatus 3; and a storage section 31 which stores various kinds of data used by the information processing apparatus 3. Moreover, the information processing apparatus 3 includes: a communication section 32 for the information processing apparatus 3 to communicate with another apparatus (e.g., the terminal apparatus 4 illustrated in FIG. 5); an input section 33 for the information processing apparatus 3 to accept input; and an output section 34 for the information processing apparatus 3 to output data. The control section 30 includes a data acquisition section 301, an inference section 302, a presentation section 303, a modification section 304, a guidance section 305, and a training section 306. The storage section 31 stores an inference model 311.

The data acquisition section 301 acquires input data pertaining to a combinational optimization problem for which a solution is to be obtained. The input data acquired by the data acquisition section 301 only needs to be data which includes information necessary for inferring a solution to an optimization problem and from which a feature can be extracted by an encoder included in the inference model 311, as with the input data described in the first example embodiment.

For example, the data acquisition section 301 may acquire the input data which includes at least any of text data describing the optimization problem in natural language and image data pertaining to the optimization problem. Thus, in addition to the example advantage of the information processing apparatus 1 in accordance with the first example embodiment, it is possible to bring about an example advantage of making it possible for the user to easily enter input data based on which an intended optimum solution can be obtained.

For example, the user can enter text “The current location is a spot A, and I want to carry out delivery at spots B, C, D, and F” as input data. The user can also input, on an image of a map, a marked image as input data in which spots where the user needs to go through are marked. Even with data in such a form, a feature can be extracted by the encoder included in the inference model 311 and a solution to an optimization problem can be generated by the decoder in accordance with the feature. Voice input by the user may be accepted. In this case, the terminal apparatus 4 or the information processing apparatus 3 may transform the voice inputted by the user into text data as input data.

The inference section 302 infers, with use of the inference model 311 for inferring a solution to an optimization problem, a solution in accordance with input data acquired by the data acquisition section 301. The inference model 311 is an inference model which has been generated by reinforcement learning applying a reward for evaluating a solution to the optimization problem, and includes an encoder that extracts a feature of input data and a decoder that generates information indicating a solution to the optimization problem using the feature extracted by the encoder. Note that the inference model 311 does not necessarily need to be stored in the information processing apparatus 3, and may be stored in another apparatus. In a case where the inference model 311 which is stored in another apparatus is used, the inference section 302 may instruct that another apparatus to carry out inference using the inference model 311 and acquire an inference result from that another apparatus.

The inference model 311 may be, for example, a model which has been generated by learning of a plurality of spots of interest and routes between the plurality of spots and infers an optimum route that goes through the plurality of spots while satisfying a predetermined condition. Such inference is demanded in various kinds of business, including delivery of packages as described above. Therefore, the above configuration brings about an example advantage of making it possible to contribute to improvement in efficiency of such business. A problem of inferring an optimum route may be, for example, a traveling salesman problem or a vehicle routing problem.

As described above, the inference section 302 causes the decoder of the inference model 311 to generate information indicating a solution to the optimization problem. An output format of the decoder can be determined as appropriate in designing the inference model. For example, the decoder may have been trained to generate at least any of image data indicating a solution to the optimization problem and text data indicating a solution to the optimization problem. Thus, in addition to the example advantage of the information processing apparatus 1 in accordance with the first example embodiment, it is possible to bring about an example advantage of making it possible to present a solution to an optimization problem to a user in a format which can be easily recognized intuitively.

For example, it is assumed that an optimization problem for which a solution is to be obtained is to infer an optimum route that goes through a plurality of spots of interest. In this case, it is possible to use an inference model 311 which includes a decoder that has been trained to output image data in which an optimum route is superimposed on a map image or text data for guidance along an optimum route.

The inference model 311 only needs to be a model including an encoder and a decoder, and may be, for example, a variational autoencoder or a transformer model. In the present example embodiment, an example is described in which the inference model 311 is a transformer model.

The presentation section 303 presents an inference result by the inference section 302 to the user. A presentation mode of the inference result is an arbitrary mode. For example, as in the example of FIG. 5, the presentation section 303 may present the inference result by causing the terminal apparatus 4 to display an image indicating the inference result. For example, the presentation section 303 may present the inference result via the output section 34. As described above, the presentation section 303 may cause the output apparatus (output section 34) included in the information processing apparatus 3 to output an inference result. Alternatively, the presentation section 303 may cause an output apparatus (e.g., the terminal apparatus 4) external to the information processing apparatus 3 to output an inference result. The presentation section 303 may cause an inference result to be output by voice or by printing.

The modification section 304 accepts user modification with respect to an inference result by the inference section 302. For example, the modification section 304 may accept modification via the terminal apparatus 4 as in the example of FIG. 5 or may accept modification via the input section 33. In a case where the modification section 304 has accepted modification, the presentation section 303 reflects the modification in the presented inference result.

The guidance section 305 carries out route guidance so that the user can carry out delivery along an optimum delivery route which has been inferred by the inference section 302 (or along a modified delivery route if the modification 304 section has accepted modification). The route guidance may be carried out by the guidance section 305 or may be carried out by another apparatus.

In a case where the guidance section 305 carries out route guidance, the guidance section 305 causes a current location of the user to be displayed on an image of the map, and also causes an optimum delivery route which has been inferred by the inference section 302 and spots (a pickup spot, a delivery destination spot, and the like) on the delivery route to be displayed. The guidance section 305 guides the user by voice and an image so that the user moves along the delivery route and can pick up and deliver packages.

Meanwhile, in a case where route guidance is carried out by another apparatus (e.g., the terminal apparatus 4 in which a navigation application is installed or an in-vehicle navigation apparatus), the guidance section 305 may notify the apparatus of the delivery route and instruct the apparatus to carry out route guidance along the delivery route.

As with the training section 22 described in the first example embodiment, the training section 306 updates the inference model 311 by reinforcement learning based on an evaluation result of the solution inferred by the inference section 302. The reinforcement learning is carried out in a framework in which (i) processes of carrying out an action decided in accordance with a policy in a certain state and calculating a reward for the action based on a state after the action are repeated, and (ii) the policy is updated so that a sum of rewards is maximized. In the reinforcement learning by the training section 306, the inference model 311 is applied as a “policy” in this framework. That is, the training section 306 repeats, until a route is completed, processes of causing the inference section 302 to infer a spot to go next to a certain spot, and calculating a reward of the inference result based on a state after the user has moved to the spot. Then, the training section 306 updates the inference model 311 such that a sum of rewards (in other words, an evaluation of all inference results) in a case where the completed route is applied is maximized.

### (Configuration of Inference Model 311)

As described above, the inference model 311 may be a transformer model. Here, a transformer model which has been caused to learn arrangements of words in natural language or the like can infer a word that will follow a word of interest, and can generate a sentence by repeating the inference.

In a case where the inference model 311 is a transformer model, instead of causing the inference model 311 to learn words and arrangement orders thereof, the inference model 311 may be caused to learn spots in an area in which an optimum delivery route is to be decided and an order of going through the spots. Thus, the inference model 311 can be generated which generates an optimum delivery route by repeating a process of inferring a spot to go next from a designated spot. The same applies to cases where other combinational optimization problems such as a knapsack problem are solved, and an optimum combination can be inferred by repeating a process of inferring one to be selected next from a plurality of combinations of interest.

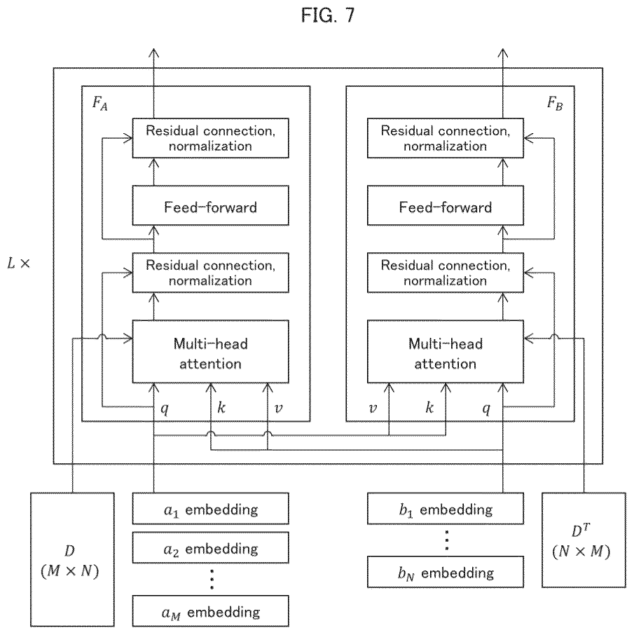

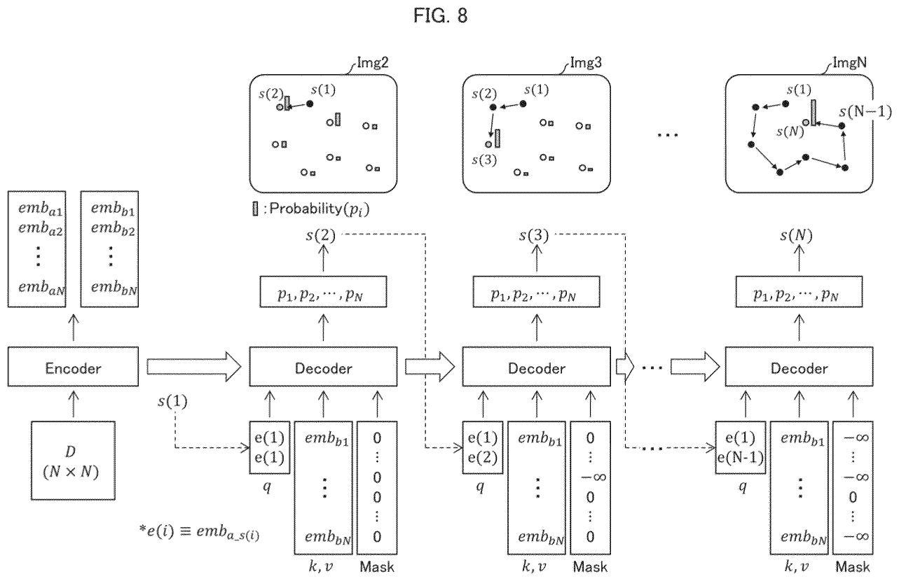

An encoder portion of the inference model 311, which is a transformer model, may be configured as in FIG. 7, for example. FIG. 7 is a diagram illustrating an example configuration of the encoder included in the inference model 311. The encoder illustrated in FIG. 7 is constituted by two parts F_{A} and F_{B}.

Here, even in a route connecting the same spots, a passage cost may vary between cases where a departure spot and an arrival spot are reversed. For example, even in a case of going along the same route, a time taken to go to a center of a city through that route may be longer than that taken to go to a suburban area. By using the two encoders F_{A} and F_{B} in combination, it is possible to carry out optimization while taking into consideration such asymmetry of a route (details will be described below).

The encoders F_{A} and F_{B} each accept input of q (query), k (key), and v (value). The encoders F_{A} and F_{B} are each constituted by of L layers each of which is constituted by two sub-layers, i.e., a multi-head attention layer and a feed-forward network layer (each involving a residual connection-normalization layer). By using the multilayer encoder, it is possible to induce learning so that a local feature is extracted in a lower layer and a global feature is extracted in a higher layer.

Although not illustrated, the decoder of the inference model 311 is similarly constituted by L layers. In addition to the two sub-layers of the encoder, a multi-head attention layer (and a residual connection-normalization layer) for receiving output from the first sub-layer is added to each layer included in the decoder. The decoder of the inference model 311 can have a configuration similar to a decoder in a transformer model which processes natural language.

In a case where the training section 306 carries out reinforcement learning of the inference model 311, input data to be given may be information (e.g., coordinates) indicating spots to which deliveries are to be carried out and routes connecting those spots. It can be said that the input data is data having a graph structure in which the above spots are indicated as nodes and the above routes are indicated as edges. Hereinafter, the input data used for training is referred to as graph data. For example, a route of moving from any of M spots (spots a₁ through a_{M}) to any of N spots (spots b₁ through b_{N}) can be expressed by graph data constituted by nodes indicating the respective spots and edges indicating routes between the spots.

In a case where the graph data is inputted to the encoder of the inference model 311, the data acquisition section 301 acquires the graph data and supplies the acquired data to the inference section 302. Then, the inference section 302 calculates embedding vectors of the respective nodes corresponding to the spots a₁ through a_{M} and b₁ through b_{N}, and inputs the embedding vectors to the multi-head attention layers of the encoders illustrated in FIG. 7.

At this time, the inference section 302 adds, to each of the embedding vectors, positional information indicating a positional relationship (in other words, an order) of the nodes to be inputted. Thus, edges between the nodes are expressed. Note that the inference section 302 may calculate embedding vectors corresponding to the respective edges and input the embedding vectors to the multi-head attention layers.

As information pertaining to routes between the spots, i.e., the edges in the graph data, the inference section 302 also inputs, to the multi-head attention layer, information D(M×N) indicating a cost (such as a travel distance) that occurs in going along the route. Here, in the inference model 311 illustrated in FIG. 7, D(M×N) is inputted to the encoder F_{A}, while D^{T}(N×M), which is a transposed matrix of D, is inputted to the encoder F_{B}. Thus, the encoder F_{A} can extract a feature while taking into consideration a cost of moving from any of the spots a₁ through a_{M} to any of the spots b₁ through b_{N}. Moreover, the encoder F_{B} can extract a feature while taking into consideration a cost of moving from any of the spots b₁ through by to any of the spots a₁ through a_{M}. Thus, by using two encoders in combination, it is possible to carry out optimization while taking into consideration asymmetry of a route. Note that, in training, the training section 306 may carry out training using, for each of routes connecting spots of interest, a cost of going in a first direction along that route and a cost of going in a second direction that is opposite to the first direction.

In addition to a cost such as a travel distance, an area name and time information can be incorporated into an attention mechanism as information pertaining to an edge. This makes it possible to incorporate a realistic structure into the encoder, as well as a simplified expression of a mathematical formula level.

Here, an attention mechanism is provided in the multi-head attention layer of the encoder of the inference model 311. Therefore, according to the encoder of the inference model 311, it is possible to extract a feature while taking into consideration not only information of neighboring nodes but also a structure of an entire graph. Specifically, a process in which an attention of each node is calculated and a feature of a node is updated based on a feature of another node having higher relevance is carried out for each node by the attention mechanism. Thus, the feature of the entire graph is reflected in the feature of each node.

Meanwhile, the decoder of the inference model 311 infers, based on the feature extracted by the encoder, a node to be selected next, in other words, a spot to go next. The decoder is trained (i.e., parameters included in the decoder are updated) by reinforcement learning so that a node which maximizes or minimizes an objective function can be selected.

In training of the decoder, it is preferable to exclude, by a mask process, a node which does not satisfy a condition to be satisfied in optimization so that such a node is not selected. This makes it possible to reduce a possibility that a solution which does not satisfy a condition is inferred, which can occur in a stochastic model, and to efficiently train a model with high performance. The above condition may be, for example, a constraint condition (e.g., not go through the same spot, pick up at a fixed pickup time, cannot pick up more than the upper limit of a capacity of a truck, and the like) by optimization or may be another condition.

As described above, in a case where the inference model 311 which is a transformer model is applied, a feature of entire graph data is reflected in features of respective nodes by the attention mechanism. Therefore, it is possible to infer an appropriate solution while taking into consideration a structure of the entire graph data.

As described above, in a case where the inference model 311 is a transformer model, the transformer model may be a model which has been trained by inputting pieces of data respectively indicating a plurality of spots to an attention layer as embedding vectors and inputting, to the attention layer, pieces of data indicating costs of going through respective routes connecting the plurality of spots. Thus, in addition to the example advantage of the information processing apparatus 1 in accordance with the first example embodiment, it is possible to bring about an example advantage of making it possible to infer an appropriate solution while appropriately taking into consideration a plurality of spots and costs of going along routes connecting the plurality of spots.

Note that the encoder of the inference model 311 may include a structure such as a recurrent neural network (RNN) or a long short term memory (LSTM). This applies to both a case where the inference model 311 is a transformer model and a case where the inference model 311 is another model.

As described above, the inference model 311 may be a model which has learned, for each of routes, a cost of going in a first direction along that route and a cost of going in a second direction that is opposite to the first direction. Thus, in addition to the example advantage of the information processing apparatus 1 in accordance with the first example embodiment, it is possible to bring about an example advantage of making it possible to infer, in a case where a cost differs depending on a direction in going along a route, an appropriate solution while taking into consideration the difference.

### (Example of Inference)

FIG. 8 is a diagram illustrating an example in which an optimum delivery route is inferred using an inference model including the encoder illustrated in FIG. 7. Specifically, in the example of FIG. 8, first, input data including information D(N×N) pertaining to edges is inputted to the encoder, and features embₐ₁ through emb_{aN} and emb_{b1} through emb_{bN} are extracted. Note that N represents the number of spots for which delivery routes are to be generated.

Next, e(1), which is a feature of a starting spot s(1) of a delivery route among the features embₐ₁ through emb_{aN} extracted by the encoder, is inputted into the decoder as q (query). Note that e(i)=emb_{a_s(1)} as illustrated in FIG. 8. To the decoder, the features emb_{b1} through emb_{bN}, which are features of spots where the user can go next to the starting spot s(1), are inputted as k (key) and v (value).

These features which are inputted to the decoder may be subjected to a mask process. For example, in a case where a spot which does not satisfy a predetermined constraint condition is included in the spots b₁ through b_{N}, by applying a mask process to a feature corresponding to the spot, it is possible to prevent the spot from being selected as a spot to go next. In a case where there is no such spot, all values of the mask may be set to zero, as illustrated in FIG. 8.

By inputting the above-described data to the decoder, the decoder outputs, for each of the spots where the user can go next to the starting spot s(1), a probability that the spot is a spot where the user should go next. In FIG. 8, the probability is indicated by pi (i=1 to N). For example, the decoder may output a location where the probability is maximum as a spot s(2) to go next to the starting spot s(1).

Next, the decoder receives input, as q, of the feature e(1) which is a feature of the starting spot s(1) and the feature e(2) which is a feature of the spot s(2) to go next. In addition, the decoder receives input, as k and v, of the features emb_{b1} through emb_{bN} which are features of spots where the user can go next to the starting spot s(1). Here, since the spot s(2) is a spot which has already been selected, a mask process is applied to a feature corresponding to the spot s(2).

Thus, the decoder outputs, for each of the spots where the user can go next in a case where the user has gone to the spot s(2) next to the starting spot s(1), a probability that the spot is a spot where the user should go. Then, for example, the decoder may output a location where the probability is maximum as a spot s(3) to go next to the spot s(2). Subsequently, by repeating a similar process, a delivery route from the starting spot s(1) to an arrival spot (N-1) is generated as illustrated in FIG. 8.

The presentation section 303 may present an inference result by the inference section 302 by presenting a completed delivery route such as ImgN illustrated in FIG. 8. The presentation section 303 may also present, to the user, a current progress until a delivery route is completed. For example, the presentation section 303 may display Img2 illustrated in FIG. 8 at a timing at which the spot s(2) is inferred as a spot to go next to the starting spot s(1). Then, the presentation section 303 may update Img2 into Img3 illustrated in FIG. 8 at a timing at which the spot s(3) is inferred as a spot to go next to the spot s(2). This makes it possible to confirm a generated portion or to start delivery along the generated portion in a period until a delivery route to the arrival spot (N−1) is completed.

Instead of outputting a spot corresponding to a maximum probability among outputted probabilities, the decoder may output spots corresponding to a predetermined number of higher probabilities or spots corresponding to probabilities equal to or greater than a predetermined upper limit. In this case, in a case where a plurality of spots are outputted by the decoder, the user may select one of the plurality of spots as a next destination. Thus, it is possible to generate an optimum delivery route while taking into consideration an intention of the user.

### (Additional Training of Inference Model 311)

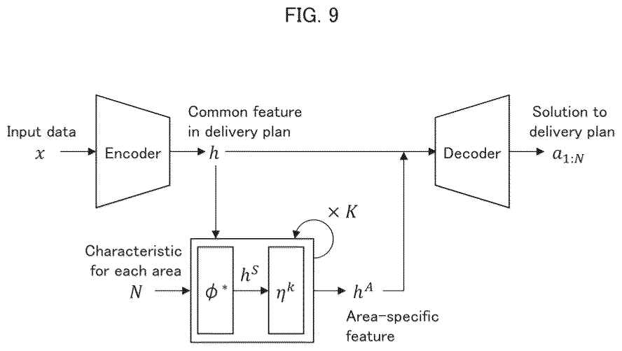

By carrying out additional training on the trained inference model 311, it is also possible to generate a proper delivery route that is suitable for an area where a delivery plan is to be prepared. This will be described with reference to FIG. 9. FIG. 9 is a diagram illustrating an example of additional training of the inference model 311. FIG. 9 illustrates the encoder and the decoder included in the inference model 311. The encoder extracts a feature of input data x and the decoder outputs an inference result a_{1:N} of a solution to a delivery plan based on the extracted feature.

In additional training, for example, a general-purpose feature h which is commonly applied in various delivery plans among features outputted by the encoder may be changed to a feature h^{A} which is applied to a particular area. Thus, the inference model 311 can be made more suitable for generation of a delivery plan in the above particular area.

In this case, the training section 306 may change a part of the output layer of the encoder which outputs the feature h so as to output the feature h^{A}. Then, as illustrated in FIG. 9, additional training may be carried out using data N including a feature of the above particular area. Thus, it is possible to change the feature h outputted by the encoder into the feature h^{A}.

The training section 306 can also add a feature extracted by the encoder in a similar manner. In this case, the training section 306 may change the output layer of the encoder so as to output a new feature h^{A} and then carry out additional training using data pertaining to the new feature h^{A}.

For example, a case is assumed in which an inference model 311 generated for a certain area is used to an area having a different city size. As a specific example, it is possible to cause an inference model 311 which has been trained with high accuracy for approximately 100 spots to generate a delivery plan for a larger city including approximately 1000 spots. In this case, additional training may be carried out by adding a feature conditioned by a city size. To be simplest, a feature of change of a city may be added. Alternatively, a new feature may be additionally learned while using a city size and a learned feature as input. Similarly, the number of trucks that can be used and a usage status of the user (e.g., redelivery, reservation information, or the like) also vary for each area, and therefore such information may be added as a feature for additional training.

As described above, it is possible for the training section 306 to change an internal representation in accordance with needs of a user by adding a new feature to a feature outputted by the encoder or by carrying out an adjustment process of changing a feature. The internal representation outputted by the encoder represents an intrinsic feature of input data. In some cases, a more appropriate internal representation can be obtained by adding a complementary feature in accordance with a purpose of a problem.

As described above, in a case where a new feature is added to an internal representation outputted by the encoder, the training section 306 may carry out additional training (additional training process) after adding a generation layer for generating a new feature to the encoder. The generation layer for generating a new feature generates a new feature while taking into consideration a feature of a problem such as an objective function or a constraint condition that reflects needs of the user.

For example, in a vehicle routing problem, a feature in accordance with a distance between spots, a features in accordance with a load capacity limit of a vehicle, a feature such as text describing individual circumstances of the user, and the like may be added to a feature outputted by the encoder. By additionally training the encoder so as to output a feature which is generated from data unique for each area in accordance with needs of the user, it is possible to generate a delivery plan which conforms to the area and the needs of the user.

In additional training or retraining, it is preferable for the decoder to change a mask process in accordance with a condition to be satisfied. Thus, it is possible to efficiently learn a condition to be satisfied. For example, pickup of a package in the evening rather than in the morning should be incorporated into a model as a hard constraint. Constraints to be observed, such as the number of available trucks and working hours of drivers, may also be added. In such a case, it is possible to quickly reflect a constraint to be observed in a model by carrying out training while appropriately changing a subject of a mask process in the decoder.

### (Flow of Process)

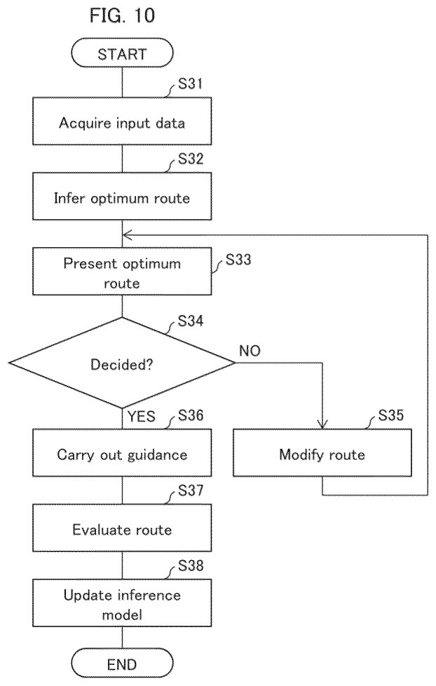

The following description will discuss a flow of a process carried out by the information processing apparatus 3, with reference to FIG. 10. FIG. 10 is a flowchart illustrating the flow of the process carried out by the information processing apparatus 3. The flow of FIG. 10 includes the steps of the inference method and the inference model generation method in accordance with the present example embodiment. In the following description, an example will be described in which the information processing apparatus 3 solves an optimization problem of inferring an optimum route that goes through a plurality of spots of interest while satisfying a predetermined condition.

In S31 (data acquisition process), the data acquisition section 301 acquires input data pertaining to a combinational optimization problem for which a solution is to be obtained. A method for acquiring the input data is not particularly limited. For example, the data acquisition section 301 may acquire input data via the communication section 32 or the input section 33.

In S32 (inference process), the inference section 302 infers, using the inference model 311, a solution (specifically, an optimum route) in accordance with the input data acquired in S31. As described above, the inference model 311 is an inference model which has been generated by reinforcement learning. The inference model 311 is an inference model for inferring a solution to an optimization problem and includes an encoder that extracts a feature of input data and a decoder that generates information indicating a solution to the optimization problem using the feature extracted by the encoder.

In S33, the presentation section 303 presents, to the user, an inference result of S32, that is, the optimum route inferred by the inference section 302. For example, as in the example of FIG. 5, the presentation section 303 may present the route to the user by causing the terminal apparatus 4 to display an image indicating the inferred optimum route on the map.

In S34, the modification section 304 determines whether or not to employ the route presented in S33 as a decided route. In a case where it has been determined that the route is decided (YES in S34), the process proceeds to S36. Meanwhile, in a case where it has been determined that the route is not decided (NO in S34), the process proceeds to S35. For example, the modification section 304 may determine that the condition is NO in S34 in a case where a predetermined modification operation is detected for the route presented in S33.

In S35, the modification section 304 modifies the route presented in S33. After modification of the route, the process returns to S33, and the presentation section 303 presents the modified route as the optimum route. The route may be modified in accordance with an instruction by the user or may be modified automatically by the modification section 304. In the latter case, the modification section 304 may decide modification content by, for example, a rule base.

In S36, the guidance section 305 carries out route guidance along the route which has been decided in S34. After completion of the route guidance, that is, after movement of the user along the decided route ends, the process proceeds to S37.

In S37, the training section 306 evaluates the route decided in S34. In evaluation of the route, the training section 306 calculates a reward by a predetermined reward function based on a time taken between spots in movement of the user along the route or the like, and calculates an evaluation value of the entire route based on the calculated reward.

In S38 (updating process), the training section 306 updates the inference model 311 by reinforcement learning based on the evaluation result in S37. As described above, the training section 306 may carry out reinforcement learning after completion of movement along the inferred optimum route. Such reinforcement learning is called offline reinforcement learning. Thus, the process of FIG. 10 ends. In a case where offline reinforcement learning is applied, the processes of S37 and S38 may be carried out, after inference of an optimum route has been carried out multiple times, with respect to a plurality of optimum routes obtained by the inference.

The training section 306 may carry out online reinforcement learning. In this case, in S32, the inference section 302 may infer a spot to go next rather than an entire route, and the training section 306 may calculate a reward for a route to the spot at a time point at which the user has reached the spot. In this case, such processes are repeated until the user reaches a final spot, and the training section 306 updates the inference model 311 by evaluating the entire route at a time point at which the user has reached the final spot.

As described above, in a case where quality of an inferred solution is evaluated, a reward is calculated based on the result, and the inference model 311 is updated using the calculated reward, it is possible to continuously improve inference accuracy of the inference model 311 by continuously using the information processing apparatus 3. Thus, each time the information processing apparatus 3 is used, an inference result with higher quality is obtained.

### [Software Implementation Example]

Some or all of the functions of the information processing apparatuses 1 and 3 may be implemented by hardware such as an integrated circuit (IC chip), or may be implemented by software.

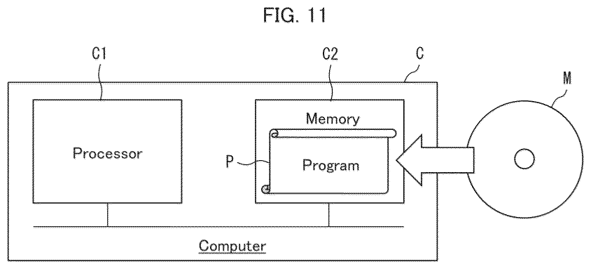

In the latter case, each of the information processing apparatuses 1 and 3 is implemented by, for example, a computer that executes instructions of a program that is software implementing the foregoing functions. FIG. 11 illustrates an example of such a computer (hereinafter, referred to as “computer C”). FIG. 11 is a block diagram illustrating a hardware configuration of the computer C which functions as the information processing apparatus 1 or 3.

The computer C includes at least one processor C1 and at least one memory C2. The memory C2 stores a program P (inference program/training program) for causing the computer C to operate as the information processing apparatus 1 or 3. In the computer C, the processor C1 reads the program P from the memory C2 and executes the program P, so that the functions of the information processing apparatus 1 or 3 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded in a case where the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

The above-described functions of the information processing apparatus 1 or 3 may be realized by a single processor provided in a single computer, may be realized by causing a plurality of processors provided in a single computer to operate together, or may be realized by causing a plurality of processors provided respectively in a plurality of computers to operate together. A program for causing the information processing apparatus 1 or 3 to realize the above-described functions may be stored in a single memory provided in a single computer, may be stored dispersedly in a plurality of memories provided in a single computer, or may be stored dispersedly in a plurality of memories provided respectively in a plurality of computers.

### [Additional Remark A]

The present disclosure includes techniques described in supplementary notes below. Note, however, that the present invention is not limited to the techniques described in supplementary notes below, but may be altered in various ways by a skilled person within the scope of the claims.

### (Supplementary Note A1)

An information processing apparatus including: a data acquisition means that acquires input data pertaining to a combinational optimization problem for which a solution is to be obtained; and an inference means that infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

### (Supplementary Note A2)

The information processing apparatus according to supplementary note A1, in which: the data acquisition means acquires the input data which includes at least any of text data describing the optimization problem in natural language and image data pertaining to the optimization problem.

### (Supplementary Note A3)

The information processing apparatus according to supplementary note A1 or A2, in which: the decoder has been trained to generate at least any of image data indicating a solution to the optimization problem and text data indicating a solution to the optimization problem.

### (Supplementary Note A4)

The information processing apparatus according to any one of supplementary notes A1 through A3, in which: the inference model is a model which has been generated by learning of a plurality of spots of interest and routes between the plurality of spots and infers an optimum route that goes through the plurality of spots while satisfying a predetermined condition.

### (Supplementary Note A5)

The information processing apparatus according to supplementary note A4, in which: the inference model is a transformer model; and the transformer model is a model which has been trained by inputting pieces of data respectively indicating the plurality of spots to an attention layer as embedding vectors and inputting, to the attention layer, pieces of data indicating costs of going through respective routes connecting the plurality of spots.

### (Supplementary Note A6)

The information processing apparatus according to supplementary note A4 or A5, in which: the inference model is a model which has learned, for each of the routes, a cost of going in a first direction along that route and a cost of going in a second direction that is opposite to the first direction.

### (Supplementary Note A7)

An information processing apparatus, including: an inference means for inferring a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and a training means for updating the inference model by reinforcement learning based on a result of evaluation of a solution which has been obtained by the inference means.

### (Supplementary Note A8)

The information processing apparatus according to supplementary note A7, in which: the training means carries out an adjustment process of changing a part of a feature to be extracted by the encoder or adding a feature to be extracted by the encoder; and the training means additionally trains the inference model after the adjustment process.

### [Additional Remark B]

### (Supplementary Note B1)

An inference method, including: a data acquisition process in which at least one processor acquires input data pertaining to a combinational optimization problem for which a solution is to be obtained; and an inference process in which the at least one processor infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

### (Supplementary Note B2)

The inference method according to supplementary note B1, in which: in the data acquisition process, the at least one processor acquires the input data which includes at least any of text data describing the optimization problem in natural language and image data pertaining to the optimization problem.

### (Supplementary Note B3)

The inference method according to supplementary note B1 or B2, in which: the decoder has been trained to generate at least any of image data indicating a solution to the optimization problem and text data indicating a solution to the optimization problem.

### (Supplementary Note B4)

The inference method according to any one of supplementary notes B1 through B3, in which: the inference model is a model which has been generated by learning of a plurality of spots of interest and routes between the plurality of spots and infers an optimum route that goes through the plurality of spots while satisfying a predetermined condition.

### (Supplementary Note B5)

The inference method according to supplementary note B4, in which: the inference model is a transformer model; and the transformer model is a model which has been trained by inputting pieces of data respectively indicating the plurality of spots to an attention layer as embedding vectors and inputting, to the attention layer, pieces of data indicating costs of going through respective routes connecting the plurality of spots.

### (Supplementary Note B6)

The inference method according to supplementary note B4 or B5, in which: the inference model is a model which has learned, for each of the routes, a cost of going in a first direction along that route and a cost of going in a second direction that is opposite to the first direction.

### (Supplementary Note B7)

An inference model generation method, including: an inference process in which at least one processor infers a solution in accordance with input data using an inference model which infers a solution a to combinational optimization problem, the inference model including an encoder that extracts a feature of the input data which is inputted to the inference model and a decoder that generates information indicating a solution to the optimization problem using the feature extracted by the encoder; and an updating process in which the at least one processor updates the inference model by reinforcement learning based on a result of evaluation of a solution which has been obtained in the inference process.

### (Supplementary Note B8)

The inference model generation method according to supplementary note B7, further including: an adjustment process of changing a part of a feature to be extracted by the encoder or adding a feature to be extracted by the encoder; and an additional training process of additionally training the inference model after the adjustment process.

### [Additional Remark C]

### (Supplementary Note C1)

An inference program for causing a computer to function as: a data acquisition means that acquires input data pertaining to a combinational optimization problem for which a solution is to be obtained; and an inference means that infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

### (Supplementary Note C2)

The inference program according to supplementary note C1, in which: the data acquisition means acquires the input data which includes at least any of text data describing the optimization problem in natural language and image data pertaining to the optimization problem.

### (Supplementary Note C3)

The inference program according to supplementary note C1 or C2, in which: the decoder has been trained to generate at least any of image data indicating a solution to the optimization problem and text data indicating a solution to the optimization problem.

### (Supplementary Note C4)

The inference program according to any one of supplementary notes C1 through C3, in which: the inference model is a model which has been generated by learning of a plurality of spots of interest and routes between the plurality of spots and infers an optimum route that goes through the plurality of spots while satisfying a predetermined condition.

### (Supplementary Note C5)

The inference program according to supplementary note C4, in which: the inference model is a transformer model; and the transformer model is a model which has been trained by inputting pieces of data respectively indicating the plurality of spots to an attention layer as embedding vectors and inputting, to the attention layer, pieces of data indicating costs of going through respective routes connecting the plurality of spots.

### (Supplementary Note C6)

The inference program according to supplementary note C4 or C5, in which: the inference model is a model which has learned, for each of the routes, a cost of going in a first direction along that route and a cost of going in a second direction that is opposite to the first direction.

### (Supplementary Note C7)

A training program for causing a computer to function as: an inference means for inferring a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and an updating means for updating the inference model by reinforcement learning based on a result of evaluation of a solution which has been obtained by the inference means.

### (Supplementary Note C8)

The training program according to supplementary note C7, further causing the computer to carry out: an adjustment process of changing a part of a feature to be extracted by the encoder or adding a feature to be extracted by the encoder; and also an additional training process of additionally training the inference model after the adjustment process.

[Additional remark D]

### (Supplementary Note D1)

An information processing apparatus, including at least one processor, the at least one processor carrying out: a data acquisition process of acquiring input data pertaining to a combinational optimization problem for which a solution is to be obtained; and an inference process of inferring a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

Note that the information processing apparatus may further include a memory. In the memory, an inference program for causing the at least one processor to carry out the above processes may be stored.

### (Supplementary Note D2)

The information processing apparatus according to supplementary note D1, in which: in the data acquisition process, the at least one processor acquires the input data which includes at least any of text data describing the optimization problem in natural language and image data pertaining to the optimization problem.

### (Supplementary Note D3)

The information processing apparatus according to supplementary note D1 or D2, in which: the decoder has been trained to generate at least any of image data indicating a solution to the optimization problem and text data indicating a solution to the optimization problem.

### (Supplementary Note D4)

The information processing apparatus according to any one of supplementary notes D1 through D3, in which: the inference model is a model which has been generated by learning of a plurality of spots of interest and routes between the plurality of spots and infers an optimum route that goes through the plurality of spots while satisfying a predetermined condition.

### (Supplementary Note D5)

The information processing apparatus according to supplementary note D4, in which: the inference model is a transformer model; and the transformer model is a model which has been trained by inputting pieces of data respectively indicating the plurality of spots to an attention layer as embedding vectors and inputting, to the attention layer, pieces of data indicating costs of going through respective routes connecting the plurality of spots.

### (Supplementary Note D6)

The information processing apparatus according to supplementary note D4 or D5, in which: the inference model is a model which has learned, for each of the routes, a cost of going in a first direction along that route and a cost of going in a second direction that is opposite to the first direction.

### (Supplementary Note D7)

An information processing apparatus including at least one processor, the at least one processor carrying out: an inference process of inferring a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and an updating process of updating the inference model by reinforcement learning based on a result of evaluation of a solution which has been obtained in the inference process.

Note that the information processing apparatus may further include a memory. In the memory, a training program for causing the at least one processor to carry out the above processes may be stored.

### (Supplementary Note D8)

The information processing apparatus according to supplementary note D7, in which: the at least one processor carries out an adjustment process of changing a part of a feature to be extracted by the encoder or adding a feature to be extracted by the encoder; and the at least one processor carries out an additional training process of additionally training the inference model after the adjustment process.

### [Additional Remark E]

### (Supplementary Note E1)

A non-transitory storage medium storing an inference program for causing a computer to carry out: a data acquisition process of acquiring input data pertaining to a combinational optimization problem for which a solution is to be obtained; and an inference process of inferring a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

### (Supplementary Note E2)

A non-transitory storage medium storing a training program for causing a computer to carry out: an inference process of inferring a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and an updating process of updating the inference model by reinforcement learning based on a result of evaluation of a solution which has been obtained in the inference process.

### REFERENCE SIGNS LIST

1: Information processing apparatus
11: Data acquisition section (data acquisition means)
12: Inference section (inference means)
3: Information processing apparatus
301: Data acquisition section (data acquisition means)
302: Inference section (inference means)
311: Inference model

1. An information processing apparatus, comprising at least one processor, the at least one processor carrying out:
a data acquisition process of acquiring input data pertaining to a combinational optimization problem for which a solution is to be obtained; and
an inference process of inferring a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

2. The information processing apparatus according to claim 1, wherein:
in the data acquisition process, the at least one processor acquires the input data which includes at least any of text data describing the optimization problem in natural language and image data pertaining to the optimization problem.

3. The information processing apparatus according to claim 1, wherein:
the decoder has been trained to generate at least any of image data indicating a solution to the optimization problem and text data indicating a solution to the optimization problem.

4. The information processing apparatus according to claim 1, wherein:
the inference model is a model which has been generated by learning of a plurality of spots of interest and routes between the plurality of spots and infers an optimum route that goes through the plurality of spots while satisfying a predetermined condition.

5. The information processing apparatus according to claim 4, wherein:
the inference model is a transformer model; and
the transformer model is a model which has been trained by inputting pieces of data respectively indicating the plurality of spots to an attention layer as embedding vectors and inputting, to the attention layer, pieces of data indicating costs of going through respective routes connecting the plurality of spots.

6. The information processing apparatus according to claim 4, wherein:
the inference model is a model which has learned, for each of the routes, a cost of going in a first direction along that route and a cost of going in a second direction that is opposite to the first direction.

7. An inference model generation method, comprising:
an inference process in which at least one processor infers a solution in accordance with input data using an inference model which infers a solution to a combinational optimization problem, the inference model including an encoder that extracts a feature of the input data which is inputted to the inference model and a decoder that generates information indicating a solution to the optimization problem using the feature extracted by the encoder; and
an updating process in which the at least one processor updates the inference model by reinforcement learning based on a result of evaluation of a solution which has been obtained in the inference process.

8. The inference model generation method according to claim 7, further comprising:
an adjustment process in which the at least one processor changes a part of a feature to be extracted by the encoder or adds a feature to be extracted by the encoder; and
an additional training process in which the at least one processor additionally trains the inference model after the adjustment process.

9. An inference method, comprising:
a data acquisition process in which at least one processor acquires input data pertaining to a combinational optimization problem for which a solution is to be obtained; and
an inference process in which the at least one processor infers a solution in accordance with the input data using an inference model which has been generated by reinforcement learning for inferring a solution to the optimization problem, the inference model including an encoder that extracts a feature of the input data and a decoder that generates information indicating a solution to the optimization problem using the feature extracted by the encoder.

10. A computer-readable non-transitory storage medium storing an inference program for causing a computer to carry out an inference method according to claim 9,
the inference program causing the computer to carry out the data acquisition process and the inference process.
